(19) United States
(12) Patent Application Publication
(10) Pub. No.: US 2012/0033772 A1
(43) Pub. Date: Feb. 9, 2012

(54) SYNCHRONISER CIRCUIT AND METHOD

(75) Inventors: Manish AGGARWAL, Noida (IN); Sanjay K. WADHWA, Noida (IN)

(73) Assignee: FREESCALE SEMICONDUCTOR, INC, Austin, TX (US)

(21) Appl. No.: 12/852,513

(22) Filed: Aug. 8, 2010

(51) Int. Cl. H04L 7/04

(52) U.S. Cl. 375/362

(57) ABSTRACT

A synchronizer circuit and method for transferring data between mutually asynchronous source and destination clock domains. An input synchronizer cell clocked at an input clock frequency receives input data from the source domain and produces a corresponding intermediate signal. A frequency divider produces a divided clock signal whose frequency is equal to the input clock frequency divided by an integer. An output synchronizer module comprises first and second cascaded synchronizer cells clocked at the divided clock frequency, receives the intermediate signal and produces a corresponding output signal for the destination clock domain.

### BACKGROUND OF THE INVENTION

The present invention is directed to a synchronizer circuit and method and, more particularly, to a synchronizer circuit and a method for transferring data between mutually asynchronous clock domains.

In complex electronic devices, it is often necessary to transfer data from one circuit module to another module that is operating in a mutually asynchronous clock domain. That is, which have different clock frequencies and/or phases. Mutually asynchronous clock domains may occur in many different situations, for example where the source and destination circuit modules are parts of separate systems, or more commonly today, in System on Chip (SoC) designs. Sometimes the source clock domain is unavailable but asynchronous data needs to be transferred to a destination circuit module, for example in clock gating, or resetting/setting the destination circuit module and in other similar situations. Asynchronous operation can lead to a risk of meta-stability in destination circuit elements, such as in registers, which have well-defined normal operating states but which may adopt an abnormal or ill-defined operating meta-stable state for a significant period, longer than a clock period, when changing from one normal state to another in response to an input data transition. The meta-stable state of a stage will typically resolve itself to a normal state eventually, provided that the destination circuit leaves sufficient time before transfer of the data to the next stage. However, failure can arise if the following stage reacts to the data before the meta-stability is correctly resolved.

Synchronizer circuits are interfaces intended to reduce the risk of occurrence of meta-stability and increase the reliability of data transfer between asynchronous clock domains. The ability of a synchronizer circuit to avoid an incipient meta-stable condition depends on several factors, including: the set-up time window C₁, which is a device-dependent constant depending on fabrication process, circuit topology and circuit element size representing the minimum delay between an input data transition and the next clock pulse which enables the device to capture the change of state of the data without meta-stability; the meta-stability resolution delay C₂, which is a device-dependent constant representing the time taken by a stage to resolve a meta-stable condition after it occurs; the settling time t_{META} that the system allows for meta-stability resolution without compromising the data transfer; and the frequency f_{data} of the data input to the synchronizer, and the clock frequency f_{clk} of the synchronizer and destination circuit.

Meta-stability being a probabilistic phenomenon, a measure of the risk is typically given by a parameter Mean Time Between Failures (‘MTBF’), which is calculated as:

$$M T B F = \frac{{e}^{{t}_{META} * {C}_{2}}}{{C}_{1} {f}_{CLK} {f}_{DATA}}$$

The greater the data and clock frequencies are, the greater is the risk of meta-stability. At high frequencies, the risk of meta-stability leading to an error in data transfer may become comparable to or greater than the risk of device failure. For example, a particular commercial product may have a synchronizer designed to work at 250 MHz, and which has a meta-stability MTBF equal to 100,000 hours (11.4 years). If the same synchronizer is run at 1 GHz, the MTBF would reduce by a factor of 4e⁴ and the MTBF would be reduced to 11.4 years/4e⁴=0.052 years, equivalent to a failure every 456.1 hours. If the same synchronizer is run at 2 GHz, the MTBF would reduce by a factor of 8e⁸ and the MTBF would be reduced to 11.4 years/8e⁸=0.000478 years, equivalent to a failure every 4.19 hours.

It is desirable to improve the compromise between operating frequencies and the risk of meta-stability. Typically, known synchronizer circuits include two cascaded cells. It is possible to increase the number of cells cascaded, but the resulting improvement in the compromise between operating frequency and risk of meta-stability, as measured by MTBF for example, is slow and incurs a penalty in increased circuit complexity. Moreover, the design of such a multiple cascaded synchronizer is complicated by the difficulty of determining the set-up time window parameter C₁ and the meta-stability resolution delay parameter C₂ of the resulting circuit.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of a conventional two-cell synchronizer circuit;

FIG. 2 is a schematic block diagram of conventional multiple-cell synchronizer circuits;

FIG. 3 is a schematic block diagram of a synchronizer circuit in accordance with one embodiment of the present invention;

FIG. 4 is a more detailed schematic diagram of an example of the synchronizer circuit of FIG. 3;

FIG. 5 is a graph of the variation with time of signals appearing in operation of the synchronizer circuit of FIG. 4 in response to a first type of input data timing;

FIG. 6 is a graph of the variation with time of signals appearing in operation of the synchronizer circuit of FIG. 4 in response to a second type of input data timing and a first type of clock timing;

FIG. 7 is a graph of the variation with time of signals appearing in operation of the synchronizer circuit of FIG. 4 in response to the second type of input data timing and a second type of clock timing; and

FIG. 8 is a flow chart of a method of transferring data in accordance with one embodiment of the invention, given by way of example, using the synchronizer circuit of FIG. 4.

### DETAILED DESCRIPTION OF PREFERRED EMBODIMENTS

In all figures clock gating of a destination clock domain is shown using a final transferred synchronized data signal DATA_SYNC to enable and disable a clock output signal CLK_OUT for the destination clock domain for better illustration. In other words, clock gating has been illustrated using different synchronizers in the different figures. However, it will be appreciated that other applications are possible, for example where the asynchronous input data signal I/P_DATA is itself data to be processed at the destination domain, the corresponding output data signal DATA_SYNC from the synchronizer being processed in the destination domain.

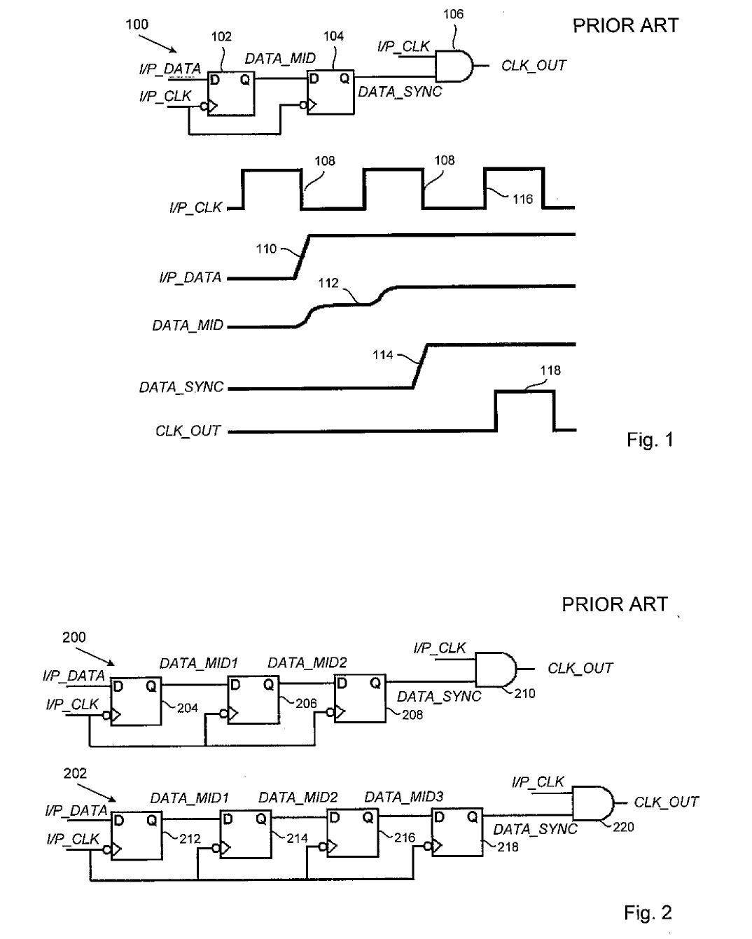

FIG. 1 shows a known two-cell synchronizer circuit 100 comprising first and second cascaded synchronizer cells 102 and 104. Typically, the cells are D flip-flops, as shown and described by way of example, although other cells can be used. The synchronizer circuit 100 receives an input data signal I/P_DATA on a D input of the first flip-flop 102 from a source circuit module (not shown) in a first clock domain. The synchronizer circuit 100 also receives an input clock signal I/P_CLK on an inverted clock input of both flip-flops 102 and 104, the input clock signal I/P_CLK being synchronous with the clock domain of the destination circuit module (not shown). The destination and source clock domains are mutually asynchronous and the objective of the synchronizer circuit 100 is to reduce the risk of meta-stability occurring in the destination circuit modules due to transfer of data transitions from the source circuit modules. A Q output of the first flip-flop 102 is connected to apply a signal DATA_MID to a D input of the second flip-flop 104. A Q output of the second flip-flop 104 is connected to apply a signal DATA_SYNC, which is a final synchronized output data signal of the synchronizer, to an input of an AND gate 106. The AND gate 106 also has an input connected to receive the input clock signal I/P_CLK and has an output providing an output clock signal CLK_OUT at an output of the synchronizer circuit 100. The AND gate is shown as used here to gate the input clock signal I/P_CLK of the destination clock domain using the synchronized output data signal DATA_SYNC of the synchronizer 100 by way of illustration.

FIG. 1 also shows a typical form of signals appearing in operation of the synchronizer circuit 100 during critical timing conditions, in which the set-up or hold times of the flip-flops 102 and 104 are violated. The flip-flops 102 and 104 are triggered to respond to the signals on their D inputs at the falling edges such as 108 of the input clock signals I/P_CLK, although they could be arranged to respond at the rising edges of the input clock signals I/P_CLK. As shown, a transition 110 in the input data signal I/P_DATA at the D input of the first flip-flop 102 coincides with the triggering edge 108 of the input clock signal I/P_CLK, so that the Q output signal DATA_MID of the first flip-flop 102 enters a meta-stable state at 112. Provided that the first flip-flop 102 resolves its meta-stable state 112 in less than one clock cycle, before the second flip-flop 104 responds to the signal DATA_MID from the first flip-flop 102 at the following triggering edge 108 of the input clock signal I/P_CLK, the second flip-flop 104 will see a stable data input and its output will adopt a stable value for the output data signal DATA_SYNC at 114, which is applied to an input of the AND gate 106. When the input clock signal I/P_CLK is next asserted at 116, both inputs of the AND gate 106 are asserted and the output clock signal CLK_OUT of the AND gate 106 is asserted at 118 in synchronization with the clock signal I/P_CLK. However, if the clock frequency is too high, the second flip-flop 104 can respond to the signal DATA_MID from the first flip-flop 102 before the first flip-flop 102 resolves its meta-stable state 112, and itself become meta-stable or even adopt an erroneous state, leading in each case to an error in data transfer to the destination circuit module or glitches in the output signal CLK_OUT.

FIG. 2 shows known multiple-cell synchronizer circuits 200 and 202. The synchronizer circuit 200 comprises three cascaded synchronizer flip-flops 204, 206 and 208. Again, a D input of the first flip-flop 204 receives an input data signal I/P_DATA from an asynchronous source circuit module and the synchronizer circuit 200 also receives an input clock signal I/P_CLK on an inverted clock input of all flip-flops 204, 206 and 208. A Q output of the first flip-flop 204 is connected to apply a signal DATA_MID1 to a D input of the second flip-flop 206. A Q output of the second flip-flop 206 is connected to apply a signal DATA_MID2 to a D input of the third flip-flop 208. A Q output of the third flip-flop 208 is connected to apply a synchronized output data signal DATA_SYNC to an input of an AND gate 210. The AND gate 210 also has an input connected to receive the input clock signal I/P_CLK and has an output providing a gated output clock signal CLK_OUT for the destination circuit module at an output of the synchronizer circuit 200.

The synchronizer circuit 202 comprises four cascaded synchronizer flip-flops 212, 214, 216 and 218. Again, a D input of the first flip-flop 212 receives an input data signal I/P_DATA from an asynchronous source circuit module and the synchronizer circuit 202 also receives an input clock signal I/P_CLK on an inverted clock input of all flip-flops 212, 214, 216 and 218. A Q output of the first flip-flop 212 is connected to apply a signal DATA_MID1 to a D input of the second flip-flop 214. A Q output of the second flip-flop 214 is connected to apply a signal DATA_MID2 to a D input of the third flip-flop 216. A Q output of the third flip-flop 216 is connected to apply a signal DATA_MID3 to a D input of the fourth flip-flop 218. A Q output of the fourth flip-flop 218 is connected to apply a synchronized output data signal DATA_SYNC to an input of an AND gate 220. The AND gate 220 also has an input connected to receive the input clock signal I/P_CLK and has an output providing a gated output clock signal CLK_OUT for the destination circuit module at an output of the synchronizer circuit 202.

For the synchronizer circuits 200 and 202, like the synchronizer circuit 100, the same input clock signals I/P_CLK, synchronous with the clock domain of the destination circuit module are applied to inverted clock inputs of all the flip-flops 102 and 104, or 204, 206 and 208, or 212, 214, 216 and 218, as well as to an input of each of the AND gates 106, 210 or 220, respectively. Although the synchronizer circuits 200 and 202 give some improvement over the circuit 100 in the compromise between operating frequency and risk of meta-stability as measured by MTBF, the improvement is slow, being proportional to the number of cells in the synchronizer circuit and incurs a comparable penalty in increased circuit complexity. Moreover, the design of such a multiple cascaded synchronizer is complicated by the difficulty of determining the set-up time window parameter C₁ and the meta-stability resolution delay parameter C₂ of the flip-flops, and therefore the optimal number of stages.

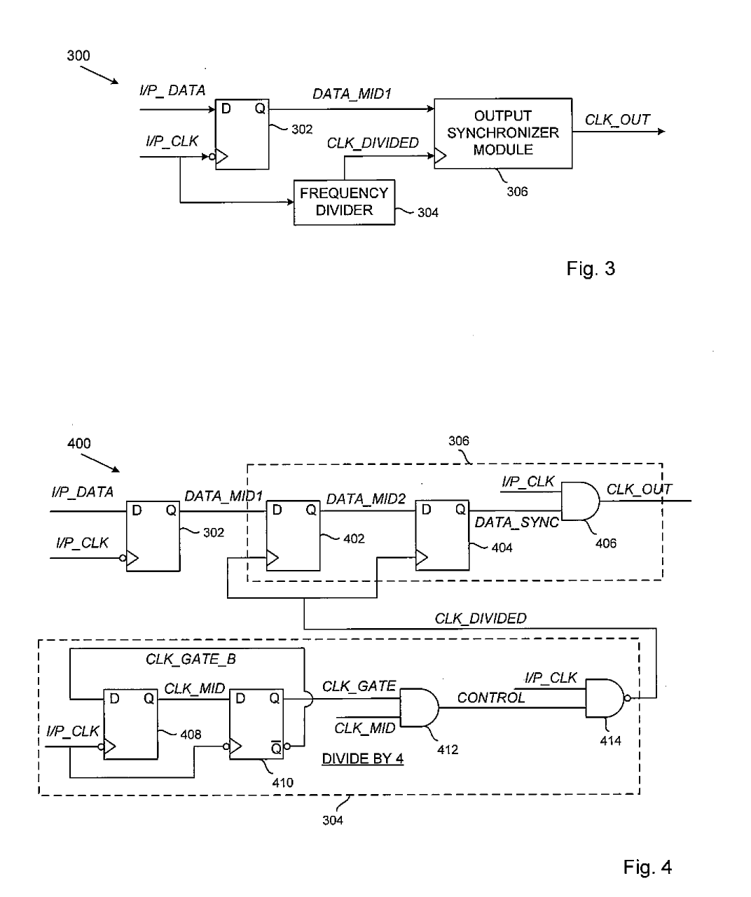

FIG. 3 shows a synchronizer circuit 300 in accordance with one embodiment of the invention, given by way of example, for transferring data between mutually asynchronous source and destination clock domains (not shown). The output of the synchronizer 300 is shown as used here to gate the clock for a destination circuit module in the destination clock domain by way of example. The synchronizer circuit 300 includes an input synchronizer cell 302 clocked at an input clock frequency I/P_CLK for receiving an input data signal I/P_DATA from the source domain and producing a corresponding intermediate data signal DATA_MID1. The input clock frequency I/P_CLK is synchronous with the destination clock domain, and therefore asynchronous with the source domain.

The synchronizer circuit 300 also includes a frequency divider 304 for producing a divided clock signal CLK_DIVIDED whose frequency is equal to the input clock frequency I/P_CLK divided by an integer N. The synchronizer circuit 300 also includes an output synchronizer module 306 comprising a plurality of cascaded synchronizer cells clocked at the divided clock frequency CLK_DIVIDED for receiving the intermediate data signal DATA_MID1 and producing a corresponding output data signal DATA_SYNC. In this example of an embodiment of the invention, the output data signal DATA_SYNC is then in turn used to gate the input clock signal I/P_CLK using an AND gate and produce a final gated clock output signal CLK_OUT.

The integer N by which the frequency divider 304 divides the input clock frequency I/P_CLK clocking the synchronizer cell 302 may be any suitable value. The following description uses the value 4 by way of example but other values may be chosen.

FIG. 4 shows an example 400 of the synchronizer circuit 300 in which the output synchronizer module 306 comprises two cascaded synchronizer cells 402 and 404 clocked at the divided clock frequency CLK_DIVIDED. The integer N by which the frequency divider 304 divides the input clock frequency I/P_CLK is 4 although other values may be chosen. In the synchronizer circuit 400, the input synchronizer cell 302 and the two cascaded synchronizer cells 402 and 404 comprise respective D flip-flops, although other cells can be used.

The synchronizer circuit 400 receives the input data signal I/P_DATA from the source domain on a D input of the input flip-flop 302 from the source circuit module (not shown) in the first clock domain. The input flip-flop 302 is clocked at the input clock frequency I/P_CLK. A Q output of the input flip-flop 302 is connected to apply an intermediate data signal DATA_MID1 to a D input of the first cascaded flip-flop 402 of the output synchronizer module 306. A Q output of the first cascaded flip-flop 402 is connected to apply a signal DATA_MID2 to a D input of the second cascaded flip-flop 404 of the output synchronizer module 306. The two cascaded flip-flops 402 and 404 are clocked at the divided clock frequency CLK_DIVIDED. A Q output of the second cascaded flip-flop 404 is connected to apply a final synchronized output data signal DATA_SYNC to an input of an AND gate 406. The AND gate 406 also has an input connected to receive the input clock signal I/P_CLK and has an output providing the gated output clock signal CLK_OUT for the destination clock domain at the output of the synchronizer circuit 400, the gated output clock signal CLK_OUT being in synchronization with the input clock signal I/P_CLK.

The frequency divider 304 of the synchronizer circuit 400 may take any suitable form. In the example shown in FIG. 4, where the division factor N is 4, the frequency divider comprises two D flip-flops 408 and 410. The flip-flops 408 and 410 are connected in twisted ring counter (or ‘Johnson counter’) configuration, the direct Q output of the flip-flop 408 being connected to apply an intermediate signal CLK_MID to the D input of the flip-flop 410, the inverted Qbar output of the flip-flop 410 being connected to apply a feedback signal CLK_GATE_B to the D input of the flip-flop 408, and both flip-flops being clocked at the input clock frequency I/P_CLK. The direct Q output of the flip-flop 410 is applied to an input of an AND gate 412, to another input of which is applied the intermediate signal CLK_MID. The output CONTROL of the AND gate 412 is applied to an input of a NAND gate 414, to another input of which is applied the input clock frequency I/P_CLK. The output of the NAND gate 414 is the divided clock signal CLK_DIVIDED applied to clock the two cascaded synchronizer cells 402 and 404. It will be appreciated that other configurations may be used for the frequency divider 304 and in particular if other division factors N than 4 are desired. A small delay is introduced between the input clock I/P_CLK and the divided clock frequency CLK_DIVIDED, corresponding to the reaction time of an AND/NAND gate, but is smaller than the reaction time of an additional flip-flop, which the frequency divider 304 avoids introducing.

The operation of the synchronizer circuit 300 will be described with reference to the operation of the example of synchronizer circuit 400. It will be appreciated that the operation of the synchronizer circuit 300 is analogous, after account is taken of possible differences of configuration and of the integer N by which the frequency divider 304 divides the input clock frequency I/P_CLK. The operation of the synchronizer circuits 300 and 400 depends on whether a transition of the input data I/P_DATA occurs within the set-up or hold windows Tsetup and Thold relative to the triggering edge of the input clock frequency I/P_CLK. The following three basic cases can occur.

### Case 1

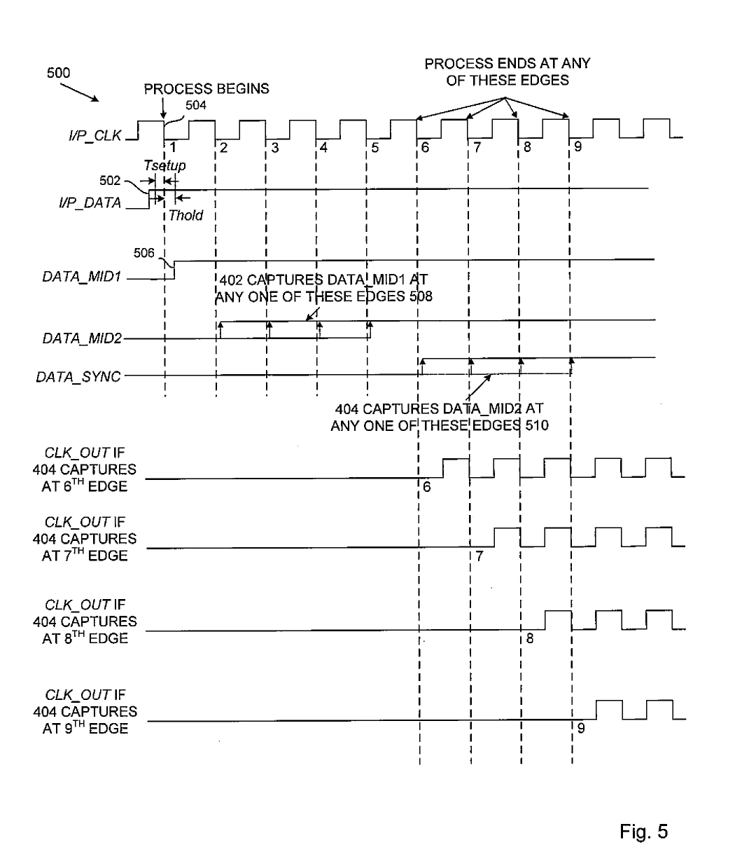

FIG. 5 illustrates operation 500 of the synchronizer circuit 400 when a transition 502 of the input data signal I/P_DATA occurs outside the set-up and hold windows Tsetup and Thold relative to the triggering edges of the input clock signal I/P_CLK. The input flip-flop 302 is able to capture the data transition 502 at the first subsequent triggering edge 504 of the input clock signal I/P_CLK and apply the corresponding transition 506 of the signal DATA_MID1 without meta-stability to the D input of the first cascaded flip-flop 402 of the output synchronizer module 306.

The first cascaded flip-flop 402 receives an input without meta-stability and can capture the transition 506 at the first subsequent triggering edge of the divided clock signal CLK_DIVIDED which occurs one, two, three or four cycles of the input clock signal I/P_CLK after the edge 504. The corresponding transition 508 of the signal DATA_MID2 is applied without meta-stability to the D input of the second cascaded flip-flop 404 of the output synchronizer module 306.

The second cascaded flip-flop 404 receives an input without meta-stability and can capture the transition 508 at the first subsequent triggering edge of the divided clock signal CLK_DIVIDED which occurs four cycles of the input clock signal I/P_CLK after the transition 508. The corresponding transition 510 of the output data signal DATA_SYNC gates the input clock signal I/P_CLK in the gate 406 and produces the gated output clock signal CLK_OUT.

Thus, depending upon when the data transition 502 occurs relative to the divided signal CLK_DIVIDED, the corresponding transition of the synchronized output data signal DATA_SYNC and gated output clock signal CLK_OUT will occur within a minimum of five (sixth−first) and a maximum of eight (ninth−first) cycles of the input clock signal I/P_CLK after the edge 504.

### Case 2

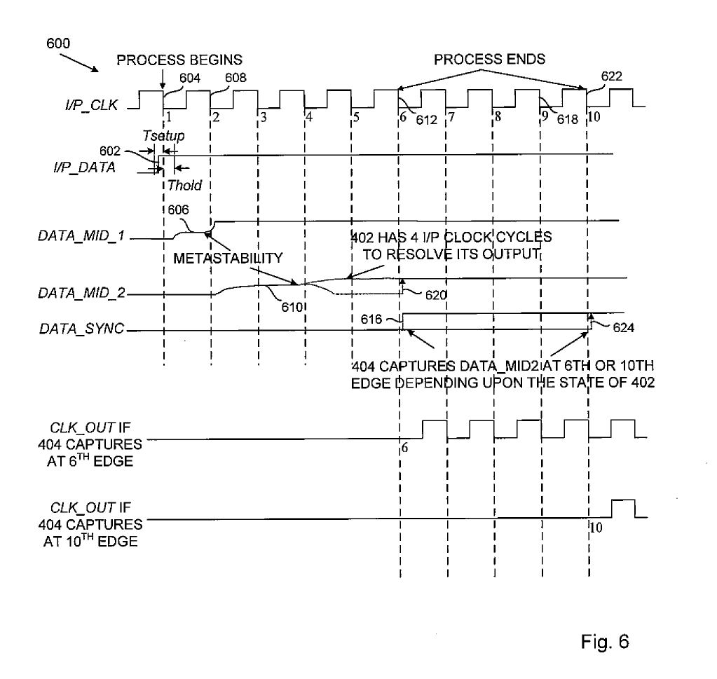

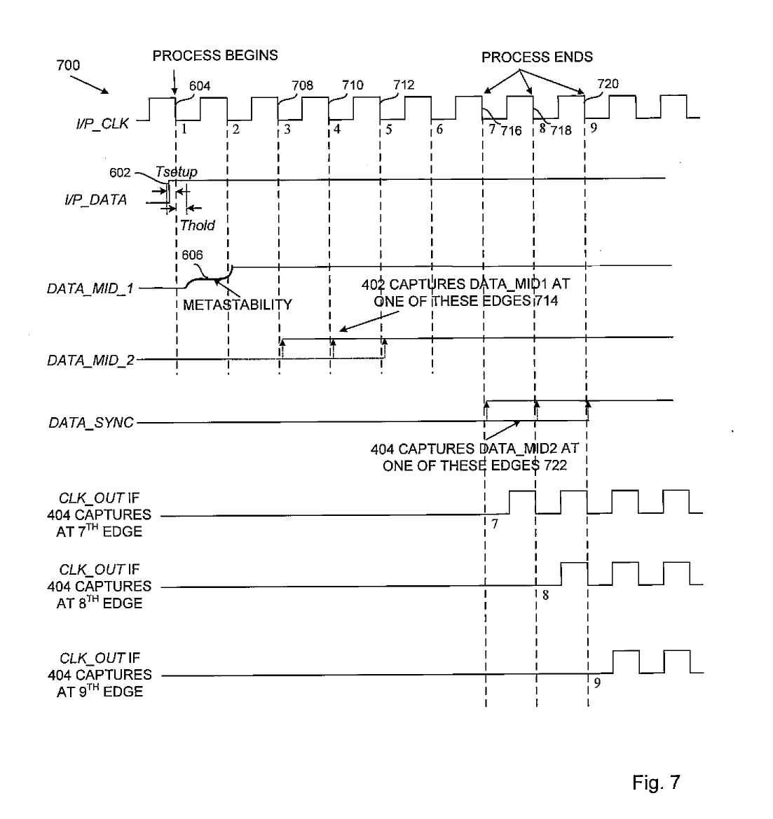

FIGS. 6 and 7 illustrate operation 600 and 700 respectively of the synchronizer circuit 400 when a transition 602 of the input data signal I/P_DATA occurs within the set-up or hold window Tsetup or Thold relative to the triggering edge 604 of the input clock signal I/P_CLK, leading to meta-stability of the corresponding transition 606 of the signal DATA_MID1 from the input flip-flop 302. FIG. 6 illustrates the case where the first subsequent triggering edge of the divided clock signal CLK_DIVIDED coincides with the first subsequent triggering edge 608 of the input clock signal I/P_CLK after the edge 604. At high clock frequencies, the meta-stable transition 606 of the signal DATA_MID1 applied to the D input of the first cascaded flip-flop 402 of the output synchronizer module 306 is then captured.

The first cascaded flip-flop 402 of the synchronizer module 306 produces a meta-stable transition 610 at the triggering edge 608 of the input clock signal I/P_CLK, like the flip-flop 102 of the synchronizer circuit 100 of FIG. 1 would do. The flip-flop 102 of the synchronizer circuit 100 of FIG. 1 has only one cycle of the input clock signal I/P_CLK to resolve its meta-stability before the transition is passed to the second flip-flop 104 of the synchronizer circuit 100. However, the second cascaded flip-flop 404 of the synchronizer module 306 will not capture the meta-stable transition 610 of the signal DATA_MID2 from the first cascaded flip-flop 402 until the next triggering edge of the divided clock signal CLK_DIVIDED, which is four cycles of the input clock signal I/P_CLK later, at 612. Accordingly, the time available for the first cascaded flip-flop 402 of the synchronizer module 306 to resolve its meta-stability is four cycles of the input clock signal I/P_CLK. The corresponding transition 610 of the signal DATA_MID2 is applied without meta-stability to the D input of the second cascaded flip-flop 404 of the output synchronizer module 306 but the signal DATA_MID2 may or may not be at the correct logic level, that is to say that after the transition of the input data signal I/P_DATA at 602 to a defined logic state, the signal DATA_MID2 might be at the same or at the opposite logic state.

If the signal DATA_MID2 is resolved to the correct logic level before the next triggering edge of the divided clock signal CLK_DIVIDED, after the edge 608, the second cascaded flip-flop 404 receives a correct input without meta-stability and can capture the transition 610 at the triggering edge of the divided clock signal CLK_DIVIDED corresponding to the edge 612 of the input clock signal I/P_CLK. The corresponding transition 616 of the synchronized output data signal DATA_SYNC then gates the input clock signal I/P_CLK in the gate 406 and produces the gated output clock signal CLK_OUT.

If the signal DATA_MID2 is not resolved to the correct logic level before the next triggering edge of the divided clock signal CLK_DIVIDED after the edge 608, the second cascaded flip-flop 404 receives a wrong transition without meta-stability, or simply no transition at the triggering edge of the divided clock signal CLK_DIVIDED corresponding to the edge 612 of the input clock signal I/P_CLK. However, at the same triggering edge of the divided clock signal CLK_DIVIDED the first cascaded flip-flop 402 produces the transition 620 of the signal DATA_MID2 which can then be captured at the next triggering edge of the divided clock signal CLK_DIVIDED corresponding to the ninth triggering edge 622 of the input clock signal I/P_CLK after the edge 604. The corresponding transition 624 of the output data signal DATA_SYNC then gates the input clock signal I/P_CLK in the gate 406 and produces the gated output clock signal CLK_OUT.

Thus, depending upon whether the signal DATA_MID2 is resolved to the correct logic level before the next triggering edge of the divided clock signal CLK_DIVIDED, that is to say by the fourth triggering edge 612 of the input clock signal I/P_CLK after the edge 608, the corresponding transition of the output data signal DATA_SYNC and the synchronized output gated clock signal CLK_OUT will occur within a minimum of five (sixth−first) and maximum of nine (tenth−first) cycles of the input clock signal I/P_CLK after the edge 604.

### Case 3

FIG. 7 illustrates another case of operation 700 of the synchronizer circuit 400 when a transition 602 of the input data signal I/P_DATA occurs within the set-up or hold windows Tsetup or Thold relative to the triggering edge 604 of the input clock signal I/P_CLK, leading to meta-stability of the corresponding transition 606 of the signal DATA_MID1 from the input flip-flop 302. FIG. 7 illustrates the case where the first subsequent triggering edge of the divided clock signal CLK_DIVIDED coincides with the second, third or fourth subsequent triggering edge 708, 710 or 712 of the input clock signal I/P_CLK after the edge 604. The transition 606 of the signal DATA_MID1 is thus resolved to its correct logic level at the first subsequent triggering edge of the input clock signal I/P_CLK after the edge 604 before it is captured by the first cascaded flip flop 402 of the output synchronizer module 306. The signal DATA_MID1 is then captured without meta-stability.

The first cascaded flip-flop 402 of the synchronizer module 306 produces a transition 714 at the triggering edge 708, 710 or 712 of the input clock signal I/P_CLK corresponding to the transition of DATA_MID1 at the first subsequent triggering edge of the divided clock signal CLK_DIVIDED after the edge 604. Then, the second cascaded flip-flop 404 of the synchronizer module 306 will capture the transition 714 of the signal DATA_MID2 from the first cascaded flip-flop 402 at the next triggering edge of the divided clock signal CLK_DIVIDED, corresponding to the triggering edge 716, 718 or 720 of the input clock signal I/P_CLK. The corresponding transition 722 of the output data signal DATA_SYNC then gates the input clock signal I/P_CLK in the gate 406 and produces the gated output clock signal CLK_OUT.

Thus, the corresponding transition of the synchronized output data signal DATA_SYNC or synchronized output gated clock signal CLK_OUT will occur within a minimum of six (seventh−first) and maximum of eight (ninth−first) cycles of the input clock signal I/P_CLK after the edge 604.

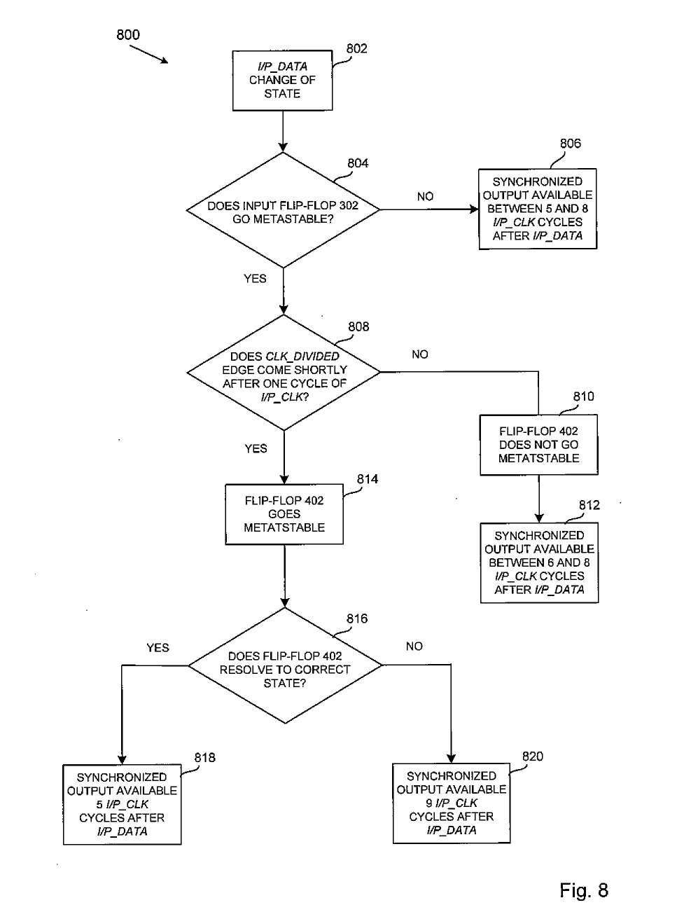

FIG. 8 illustrates an example of a synchronizer method 800 for transferring data between mutually asynchronous source and destination clock domains applicable to the synchronizer circuits 300 of FIG. 3 and 400 of FIG. 4. An input synchronizer cell 302 clocked at an input clock frequency I/P_CLK receives an input data signal I/P_DATA from the source domain and produces a corresponding intermediate data signal DATA_MID1. A frequency divider 304 produces a divided clock signal CLK_DIVIDED whose frequency is equal to the input clock frequency divided by an integer N. An output synchronizer module 306 comprises first and second cascaded synchronizer cells clocked at the divided clock frequency CLK_DIVIDED, receives the intermediate data signal DATA_MID1 and produces a corresponding gated output clock signal CLK_OUT for the destination clock domain.

A change of state of the input data signal I/P_DATA from the source domain occurs at 802. At 804, if the input cell 302 does not go meta-stable, the gated output clock signal CLK_OUT is available at 806 between 5 and 8 input clock cycles I/P_CLK after the transition 802 in the input data I/P_DATA. If, at 804, the input cell 302 does go meta-stable, the operation depends on whether or not at 808, the divided clock edge CLK_DIVIDED comes shortly after one cycle of the input clock signal I/P_CLK.

If, at 808, the divided clock edge CLK_DIVIDED comes after more than one complete cycle of the input clock I/P_CLK, meta-stability of the first cascaded synchronizer cell 402 does not occur at 810, and the gated output clock signal CLK_OUT is available at 812 between 6 and 8 input clock cycles I/P_CLK after the transition 802 in the input data signal I/P_DATA.

If, at 808, the divided clock edge CLK_DIVIDED comes shortly after a single cycle of the input clock signal I/P_CLK, meta-stability of the first cascaded synchronizer cell 402 occurs at 814, and the operation depends on whether at 816 the output of the first synchronizer cell 402 resolves to the correct logic state, corresponding to the logic state of the input data signal I/P_DATA. If so, the gated output clock signal CLK_OUT is available at 818, 5 input clock cycles I/P_CLK after the transition 802 in the input data signal I/P_DATA. If not, the gated output clock signal CLK_OUT is available at 820 9 input clock cycles I/P_CLK after the transition 802 in the input data signal I/P_DATA.

The synchronizer circuits 300 and 400 thus consume at most nine (9) input clock cycles before transition occurs at the output corresponding to the input data transition and in many applications this input data to output data latency is acceptable.

The synchronizer circuits 300 and 400 are capable of operating at clock frequencies approximately Ne^{N} times faster than the synchronizer circuit 100 at the same MTBF, where N is the division factor of the clock frequency divider, provided the repetition rate of a series of transitions in the input and output data is not excessive, This may be the case where the clock frequency of the destination clock domain is substantially faster than the clock frequency of the source clock domain, for example. It may also be the case where the source clock domain is missing (in clock gating or setting/resetting the destination circuit module) and simply asynchronous data is needed to be transferred/captured to destination clock domain. In other words, at the same clock and data frequencies the synchronizer circuits 300 and 400 are capable of MTBF a factor approximately Ne^{N} greater than the synchronizer circuit 100. The additional latency of synchronizer circuits 300 and 400 due to the clock frequency division, that is to say the propagation delay of the data transitions from the input clock cycle edge to the output data transition edge is equivalent to only one standard gate delay (NAND or NOR or AND), and is acceptable for many applications.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

The terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Further, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A synchronizer circuit for transferring data between mutually asynchronous source and destination clock domains comprising:
an input synchronizer cell clocked at an input clock frequency for receiving input data from said source domain and producing a corresponding intermediate data signal;
a frequency divider for producing a divided clock signal whose frequency is equal to said input clock frequency divided by an integer; and
an output synchronizer module comprising a plurality of cascaded synchronizer cells clocked at said divided clock frequency for receiving said intermediate data signal and producing a corresponding output data signal for said destination clock domain.

2. The synchronizer circuit of claim 1, wherein said input clock frequency is synchronous with said destination clock domain.

3. The synchronizer circuit of claim 1, wherein said synchronizer module includes an output gate for receiving an input clock signal at said input clock frequency and said output data signal and producing a gated output clock signal for said destination clock domain.

4. The synchronizer circuit of claim 1, wherein said input synchronizer cell and said cascaded synchronizer cells comprise respective flip-flops.

5. The synchronizer circuit of claim 1, wherein said frequency divider includes a frequency divider gate clocked at said input clock frequency for gating said divided clock signal.

6. A method of transferring data between mutually asynchronous source and destination clock domains comprising:
receiving input data from said source domain at an input synchronizer cell clocked at an input clock frequency and producing a corresponding intermediate data signal;
producing a divided clock signal whose frequency is equal to said input clock frequency divided by an integer; and
receiving said intermediate data signal at an output synchronizer module comprising a plurality of cascaded synchronizer cells clocked at said divided clock frequency and producing a corresponding output data signal for said destination clock domain.

7. The method of transferring data of claim 6, wherein said input clock frequency is synchronous with said destination clock domain.

8. The method of transferring data of claim 6, wherein an output gate receives an input clock signal at said input clock frequency and said output data signal and produces a gated output clock signal for said destination clock domain.

9. The method of transferring data of claim 6, wherein said input synchronizer cell and said cascaded synchronizer cells comprise respective flip-flops.

10. The method of transferring data of claim 6, wherein said divided clock signal is gated in a gate clocked at said input clock frequency.
